(19) United States
(12) Patent Application Publication
(10) Pub. No.: US 2011/0103500 A1
(43) Pub. Date: May 5, 2011

(54) Methods and apparatus for estimating a sparse channel

(75) Inventors: Martin Vetterli, Grandvaux (CH); Ali Hormati, Chavannes (CH); Yann Barbotin, Renens (CH)

(73) Assignee: QUALCOMM Incorporated, San Diego, CA (US)

(21) Appl. No.: 12/913,687

(22) Filed: Oct. 27, 2010

Related U.S. Application Data
(60) Provisional application No. 61/256,490, filed on Oct. 30, 2009.

(51) Int. Cl. H04L 27/28

(52) U.S. Cl. 375/260

(57) ABSTRACT

Embodiments include a method for sending a selected number of pilots (20) to a sparse channel having a channel impulse response limited in time comprising sending the selected number of the pilots (20). The pilots (20) are equally spaced in the frequency domain the number is selected based on the finite rate of innovation of the channel impulse response. Once received the pilots (20), such a channel is estimated by: low-pass filtering (100) the received pilots, sampling (200) the filtered pilots with a rate below the Nyquist rate of the pilots, applying a FFT (300) on the sampled pilots, verifying (500) the level of noise of the transformed pilots, if the level of noise is below to a determined threshold, applying an annihilating filter method (600) to the transformed pilots, and dividing the temporal parameters by the distance (D) between two consecutive pilots.

### RELATED APPLICATIONS

This application claims the benefit of U.S. Provisional Application No. 61/256,490, filed on 30, Oct. 2009, which is hereby incorporated by reference in its entirety.

### TECHNICAL FIELD

This disclosure relates to a method and an apparatus for sending a selected number of pilots to a sparse channel having a channel impulse response limited in time (transmission side) and a method and an apparatus for estimating such a channel (reception side).

This method and apparatus can be applied to various situations where an estimation of a sparse channel having a channel impulse response limited in time by using a selected number of pilots is required, such as without restrictions in some wireless communication channels, as OFDM and CDMA channels, e.g. CDMA channels using the Walsh-Hadamard code.

### BACKGROUND

An impulse response of an indoor/outdoor channel (CIR) has two main features:
It is limited in time, as illustrated in FIGS. 1 and 3. The delay-spread, i.e. the length of the interval wherein the impulse response is different from zero, named τₘₐₓ in FIG. 3, is typically less than 0.5 μs indoor and less than 5 μs outdoor. Moreover, since the impulse response is limited in time, it is “smooth” in the frequency domain.
It is sparse in time, i.e. it consists of few well localized signals, due for examples to different paths of echos in an acoustic room. In this context the adjective “sparse”, referred to a channel, means “sparse in time”. FIG. 2 illustrates an example of such an impulse response.

An example of a sparse channel limited in time is a channel whose impulse response h(t) can be modeled as a linear combination of several Diracs, i.e.:

$$h ( t ) = {\sum }_{k = 1}^{K} {c}_{k} δ ( t - {t}_{k} ) {t}_{k} ∈ [ {τ}_{0} ; {τ}_{f} [ ⊆ [ 0 ; {T}_{S} [ \qquad ( 1 )$$

where K is the sparsity of the channel, {cₖ}ₖ₌₁^{K} and {tₖ}ₖ₌₁^{K} are some unknown parameters, respectively the amplitude and the delay of the k^{th} path and τₘₐₓ=τ_{f}−τ₀ is the maximum delay-spread.

x(t) is the input signal of such a channel and it is supposed to comprise symbols of temporal length Tₛ, with a cyclic prefix of length τ: in such a case the filtering by the channel impulse response of one symbol can be expressed as a circular convolution. x(t) can then be considered as a periodic signal with a period equal to Tₛ.

In the considered channel the maximum delay-spread is such that

τₘₐₓ>>T_{S} (2)

In many practical cases for estimating such a channel some time/frequency tiles, or DFT coefficients, named pilots, whose value is known at the receiver, are sent through the channel. In this context the noun “pilot” indicated a DFT domain pilot, i.e. a pilot in the frequency domain. FIGS. 4 to 6 show three possible pilots' layouts: FIG. 4 shows “block” pilots, FIG. 5 “comb” pilots and FIG. 6 “scattered” pilots. In each of these figures pilots are represented by black circles 20 and data by white circles 10. Each column, in the time/frequency domain, represents a symbol. If one considers in the layout of FIG. 4 a column, in the particular instant of corresponding to this column a set or block of pilots, each pilots having a different frequency, is sent to the channel-from where the name “block” pilots of this layout. In FIG. 5 for a fixed time a pilot 20 is followed and preceded by some data 10. Each column of FIG. 6 is a delayed version of the respective column of FIG. 5.

FIG. 7 illustrates a simplified example of a TX/RX chain using pilots for estimating a channel having the two above properties. A Discrete Fourier Transform is applied to the input signal xᵢₙ and its DFT coefficients (FIG. 8) are sent to a channel having an impulse response H, shown in FIG. 9, which has to be estimate. The inverse of the impulse response of the channel, named H⁻¹ and represented in FIG. 11, is applied to the output y of the channel, illustrated in FIG. 10, in order to obtain a signal \tilde{x}. The inverse of the applied DFT is then calculated on the \tilde{x} and a signal \hat{x} is obtained. In the ideal case \hat{x} is equal to xᵢₙ.

Sending some pilots whose value is known at the receiver through the channel of FIG. 7 allows to estimate the impulse response of the channel and then to build its inverse such that \hat{x} be more similar as possible to xᵢₙ.

FIG. 12 illustrates a time/frequency plane for an OFDM system. As known, an OFDM system uses a frequency-division multiplexing: a large number of closely-spaced orthogonal sub-carriers are used to carry data. The data is divided into several parallel data streams or channels, one for each sub-carrier. Each sub-carrier is modulated with a conventional modulation scheme, e.g. QAM, at a low symbol rate, maintaining total data rates similar to conventional single-carrier modulation schemes in the same bandwidth. Such parallel channels, each having a fixed and narrow frequency-band, are represented by the rows in the plane of FIG. 12. Each column represents a symbol or a frame. FIG. 13 shows a signal for such a fixed narrow frequency-band.

A known solution for a channel impulse response estimation method, widely used in OFDM communication systems, comprises a low-pass filtering and interpolation of the pilots' spectrum. This solution removes some noise of the channel without any distortion if the bandwidth of the filter is well chosen. Although this solution is simple to realize, it presents some drawbacks since a huge number of pilots is sent to the channel for better interpolating its impulse response from the received pilots. In such interpolation step, the bigger the number of pilots, the better the estimation of the channel, the lower the bandwidth for the data signals. In other words if the number of pilots is reduced for allowing the sending of a bigger number of data, the estimation of the channel will be less robust and some errors can occur.

Moreover the low-pass filter of this method does not eliminate all the channel noise. Finally it does not allow to estimate the parameters {cₖ}ₖ₌₁^{K} and {tₖ}ₖ₌₁^{K} of the channel. Finally this solution takes advantage only of one property of the impulse response of the channel, i.e. its limitation in time.

As known in a CDMA system a special coding scheme where each transmitter is assigned to a code is used to allow multiple users to be multiplexed over the same physical channel. In other words the main operations' domain of a CDMA system is not the frequency domain as in the case of an OFDM system, but the multiplexing is realized in the code domain. A possible solution for mitigating the channel impulse response effects, used in the CDMA systems, is the coherent summation by means of a Rake Receiver, which uses jointly several sub-receivers, or fingers, i.e. several correlators, each assigned to a different multipath component. This method uses the two mentioned properties of the channel. However the precision of this method is related to its complexity, i.e. the more precise the method, the higher its computation complexity. In other words in order to resolve K paths that are close (inferior bandwidth), this method has to jointly estimate these paths (as FRI), which means searching for maximum correlation in a large subspace of dimension K. Moreover it works only for CDMA systems and in a multipath scenario and does not seem to have been applied to an OFDM system.

A method and an apparatus for estimating a sparse channel having an impulse response limited in time by using pilots, reducing the density of pilots in an OFDM system or in any OxDM system, without reducing the robustness against the noise, are needed.

A method and an apparatus for estimating a sparse channel having an impulse response limited in time by using pilots with an improved estimation accuracy are needed.

A method and an apparatus for estimating a sparse CDMA channel having an impulse response limited in time by using pilots as in a OFDM channel and simpler than the known methods in the case of high precision requirements are needed.

### SUMMARY

In general, this disclosure describes techniques for sending a selected number of pilots to a sparse channel having an impulse response limited in time and for estimating such a sparse channel.

The approach described above for an OFDM channel does not exploit at the same time the two mentioned properties of the channel, but only one property, i.e. only the limitation in time of its impulse response.

Intuitively, since the impulse response in (1) can be specified by only a small number of parameters, i.e. 2K, one should expect a much more efficient scheme in estimating the channel.

The number of pilots is selected based on the finite rate of innovation of the channel impulse response; in one embodiment this number is equal or superior to 2K+1, wherein K is the number of paths in the a multi-paths channel. In one embodiment, this number is selected based also to the noise of the channel: in fact if the channel has low noise, a low number of pilots, e.g. 2K+1, allows to robustly estimate its impulse response. It is also possible to send number of pilots higher than 2K+1: in such a case the redundancy is efficiently exploited to make the estimation more robust against noise.

Preferably this selected number of pilots is allocated in the frequency domain such that they are equally spaced. In one embodiment the maximum distance between two consecutive pilots is given by the floor function of the ratio between the length of a symbol sent to the channel and the max delay spread of the impulse response of this channel. If the channel has not an impulse response limited in time, i.e. the max delay spread tends to infinity, this distance becomes zero, i.e. the pilots are contiguous.

The method according to the one embodiment invention can be preferably used for a CDMA channel which uses a code composed by two sets of vectors independent in the frequency domain: in such a case it is possible to fix the desired pilots positions in the frequency domain by acting on one of these sets of such a code. In one embodiment such a code is the widely used Walsh-Hadamard code.

In one example a method for sending a selected number of pilots to a sparse channel having a channel impulse response limited in time includes
sending said selected number of said pilots
wherein
said pilots are equally spaced in the frequency domain; and
said number is selected based on the finite rate of innovation of said channel impulse response.

In another example a computer-readable medium, such as a computer-readable storage medium for causing an apparatus to send a selected number of pilots to a sparse channel having a channel impulse response limited in time, is encoded with instructions that cause a programmable processor to
send said selected number of said pilots;
wherein
said pilots are equally spaced in the frequency domain;
said number is selected based on the finite rate of innovation of said channel impulse response.

In another example, an apparatus for sending a selected number of pilots to a sparse channel having a channel impulse response limited in time, includes
means for sending said selected number of said pilots
wherein
said pilots are equally spaced in the frequency domain; and
said number is selected based on the finite rate of innovation of said channel impulse response.

In another example, an apparatus for sending a selected number of pilots to a sparse channel having a channel impulse response limited in time, includes
an emitting circuit arranged for sending said selected number of said pilots
wherein
said pilots are equally spaced in the frequency domain; and
said number is selected based on the finite rate of innovation of said channel impulse response.

In one embodiment this apparatus is a radio-transmitter. In one embodiment this radio-transmitter is a base station.

In another embodiment the apparatus is an acoustic echo canceller transmitter.

In another embodiment the apparatus is a line echo canceller transmitter.

In another example, a method for estimating a sparse channel having a channel impulse response limited in time includes
receiving a selected number of pilots
wherein
said pilots are equally spaced in the frequency domain;
low-pass filtering said received pilots and obtaining filtered pilots;
sampling said filtered pilots with a rate below the Nyquist rate of said pilots, and obtaining sampled pilots;
applying a FFT on said sampled pilots and obtaining transformed pilots;
verifying the level of noise of said transformed pilots;
if said level of noise is below to a determined threshold, applying an annihilating filter method to said transformed pilots and obtaining temporal parameters of said channel;
dividing said temporal parameters by the distance between two consecutive pilots.

In another example a computer-readable medium, such as a computer-readable storage medium, for estimating a sparse channel having a channel impulse response limited in time, is encoded with instructions that cause a programmable processor to
cause an apparatus to receive a selected number of pilots
wherein
said pilots are equally spaced in the frequency domain;
low-pass filter said received pilots and obtain filtered pilots;
sample said filtered pilots with a rate below the Nyquist rate of said pilots and obtain sampled pilots;
apply a FFT on said sampled pilots and obtain transformed pilots;
verify the level of noise of said transformed pilots;
if said level of noise is below to a determined threshold, apply an annihilating filter method to said transformed pilots and obtain temporal parameters of said channel;
divide said temporal parameters by the distance between two consecutive pilots;
solve a linear algebraic system containing said temporal parameters and said sampled pilots and compute amplitude parameters of said channel;
apply a denoising procedure if said level of noise is above said determined threshold.

In another example, an apparatus for estimating a sparse channel having a channel impulse response limited in time, includes
means for receiving a selected number of pilots
wherein
said pilots are equally spaced in the frequency domain;
means for low-pass filtering said received pilots and obtaining filtered pilots;
means for sampling said filtered pilots with a rate below the Nyquist rate of said pilots and obtaining sampled pilots;
means for applying a FFT on said sampled pilots and obtaining transformed pilots;
means for verifying the level of noise of said transformed pilots;
if said level of noise is below to a determined threshold, means for applying an annihilating filter method to said transformed pilots and obtaining temporal parameters of said channel;
means for dividing said temporal parameters by the distance between two consecutive pilots;
means for solving a linear algebraic system containing said temporal parameters and said sampled pilots and computing amplitude parameters of said channel;
means for applying a denoising procedure if said level of noise is above said determined threshold.

In another example, an apparatus for estimating a sparse channel having a channel impulse response limited in time, includes
a circuit arranged to receive a selected number of pilots
wherein
said pilots are equally spaced in the frequency domain;
a low-pass filter arranged to low-pass filter said received pilots and obtain filtered pilots;
a sampler arranged to sample said filtered pilots with a rate below the Nyquist rate of said pilots and obtain sampled pilots;
a second calculator arranged to apply a FFT on said sampled pilots and obtain transformed pilots;
a third calculator arranged to verify the level of noise of said transformed pilots;
if said level of noise is below to a determined threshold, a fourth calculator arranged to apply an annihilating filter method to said transformed pilots and obtain temporal parameters of said channel;
a fifth calculator arranged to divide said temporal parameters by the distance between two consecutive pilots;
a sixth calculator arranged to solve a linear algebraic system containing said temporal parameters and said sampled pilots and computing amplitude parameters of said channel;
a seventh calculator arranged to apply a denoising procedure if said level of noise is above said determined threshold.

In one embodiment the apparatus can be a radio-transmitter.

In one embodiment, the radio-transmitter is a mobile phone.

In another embodiment the apparatus can be an acoustic echo canceller.

In another embodiment the apparatus can be a line echo canceller.

The method and apparatus for estimating a sparse channel having a channel impulse response limited in time work also for sample rate higher than the Nyquist rate.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a chart illustrating an impulse response of a channel limited in time

FIG. 2 is a chart illustrating an impulse response of a sparse channel.

FIG. 3 is a chart illustrating an impulse response limited in time of a sparse channel.

FIGS. 4 to 6 are charts illustrating pilots' layouts in the time/frequency plane.

FIG. 7 is a block diagram illustrating a simplified TX/RX chain using pilots for estimating a channel.

FIGS. 8 to 11 is a chart illustrating in the frequency domain respectively the signal after the DFT block of FIG. 7, the impulse response of the channel of FIG. 7, the received signal, and the inverse of the impulse response of the channel of FIG. 7.

FIG. 12 is a chart illustrating a time/frequency plane for an OFDM system.

FIG. 13 is a chart illustrating a signal for a fixed narrow frequency-band of the FIG. 12.

FIG. 14 is a chart illustrating a time/frequency plane for an OFDM system with some pilots equally spaced.

FIG. 15 is a chart illustrating an interpolation method for estimating a sparse channel having an impulse response limited in time.

FIG. 16 is a chart illustrating a time/frequency plane for an OFDM system with some contiguous pilots around the baseband.

FIG. 17 is a chart illustrating an extrapolation method for estimating a sparse channel having an impulse response limited in time.

FIG. 18 is a block diagram illustrating the sampling of a FRI signal, with indications of potential noise perturbations in the analog and in the digital part.

FIG. 19 is a block diagram illustrating the FRI retrieval method in the noisy case after the sampling part.

FIGS. 20 and 21 are block diagrams illustrating respectively a TX and a RX chain for an Orthogonal Hadamard Division Multiplexing (OHDM) system.

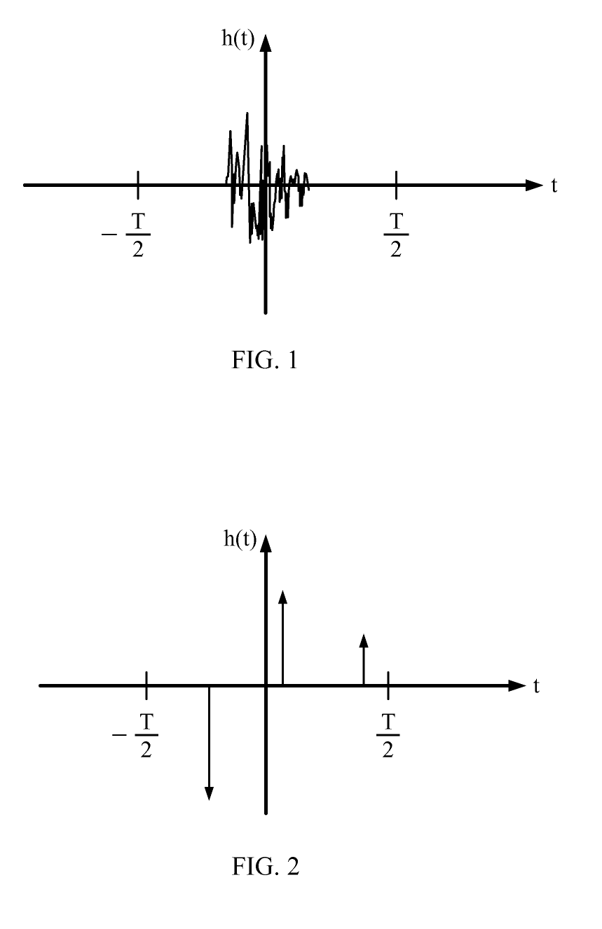

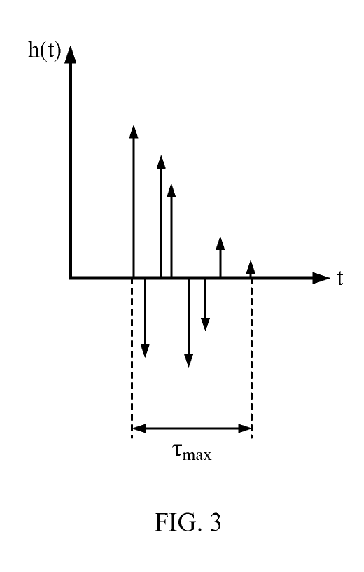

### DETAILED DESCRIPTION

In the frequency domain pilots can be represented by some DFT coefficients, which are known for some indices p in the following interval

P={p|0≦pₘᵢₙ≦p≦pₘₐₓ≦N,p=lD,lεZ} (3)

where D is distance between two consecutive pilots. Moreover it is assumed that the cardinality of P in (3) is superior then 2K.

According to one embodiment of the invention a selected number of pilots equally spaced in the frequency domain are sent to a sparse channel having an impulse response limited in time for its estimation. Since these pilots evenly spaced cover the whole available channel spectrum, an interpolation method, illustrated in FIG. 15, will be used for estimating such a channel. FIG. 14 shows a time/frequency plane for an OFDM system with some pilots equally spaced: D indicates the distance between two consecutive pilots.

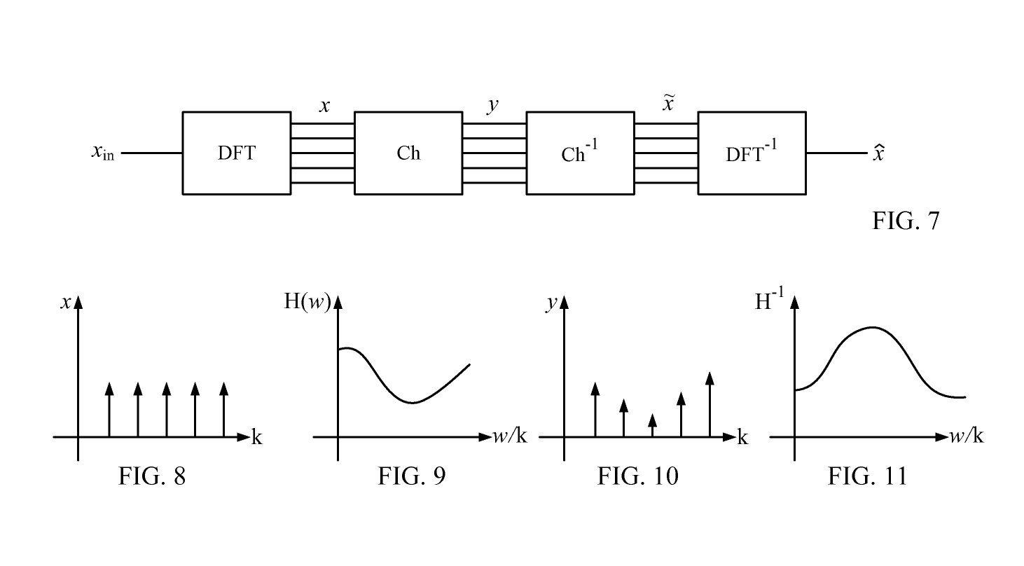

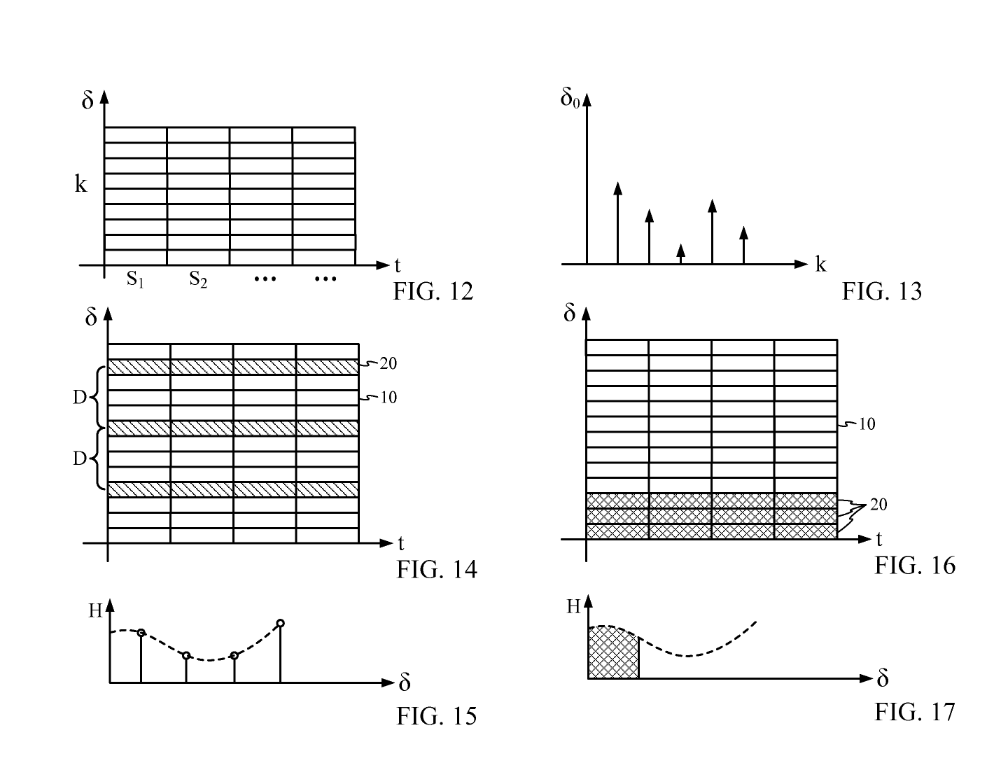

A first issue is the aliasing, i.e. what is the maximum space allowed between two consecutive pilots such that the channel impulse response can be unambiguously estimated. Assuming good synchronisation between the transmitter and the receiver side of the chain of FIG. 7 is possible, for an unambiguous recovery of the delays {tₖ}ₖ₌₁^{K} according to (1), the following condition has to be respected

τ₀≦tₖ<τ₀+T_{S}/D (4)

It amounts to require the delay-spread τ to be less than a fraction 1/D of the symbol length T_{S}. In other words the maximum delay-spread τₘₐₓ has to be equal than a fraction 1/D of the symbol length T_{S}. Consequently the maximum distance D, i.e. the maximum number of samples between two consecutive pilots is given by

$${D}_{max} = ⌊ \frac{{T}_{S}}{{τ}_{max}} ⌋ \qquad ( 5 )$$

where └ ┘ indicated the floor function.

Any method based on pilots separated by a maximum of Dₘₐₓ samples uses by default the property of the limitation in time of the impulse response of the channel. In fact if the channel has not an impulse response limited in time, i.e. τₘₐₓ→∞, the distance Dₘₐₓ becomes zero, i.e. the pilots are contiguous. In practice D is picked as large as possible, e.g. equal to Dₘₐₓ for augmenting the robustness against the noise of the estimation method.

According to one embodiment of the invention a selected number of pilots equally spaced in the frequency domain are sent to a sparse channel having an impulse response limited in time. For estimating such a channel this selected number of pilots is received and at the receiver part of the chain of FIG. 7 the FRI method in a noisy case as described in the paper T Blu, P.-L. Dragotti, M. Vetterli, P. Marziliano, and L. Coulot Sparse Sampling of Signal Innovations. IEEE Signal Processing Magazine, 25(2): 31-40, March 2008 can be applied, the only modification being tₖ←tₖ/D or, in other words, the founded solutions tₖ have to be divided by D.

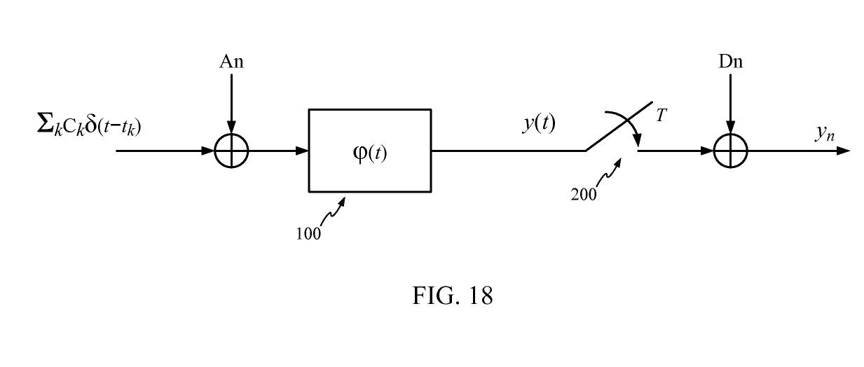

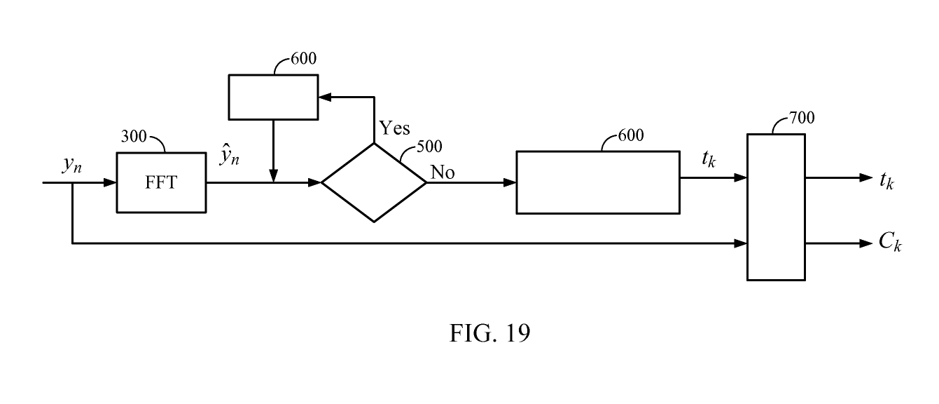

FIGS. 18 and 19 show a schematic and simplified block diagram representation of such FRI retrieval method in the noisy case. Such a method is performed at the receiver part of a TX/RX chain. As illustrated in FIG. 18 noise can be introduced in the analog domain (reference Aₙ in the FIG. 18) during, e.g., a transmission procedure, and in the digital domain (reference Dₙ in the FIG. 18) after sampling and in this respect, quantization is a source of corruption as well.

According to the estimation method the received signal is low-pas filtered. An example of this low-pass filtering can be found in US20100238991. The procedure is now detailed for the sinc filter (which is a particular case).

The received signal is convolved with a sinc-window named φ(t):

$$ϕ ( t ) = \frac{sin ( π Bt )}{B τ sin ( π t / τ )} \qquad ( 6 )$$

φ(t) is then a τ-periodic sinc function or Dirichlet kernel having a bandwidth B, where Bτ is an odd integer.

x(t) and y(t) are the input and output signal of the channel to estimate, respectively. As discussed, it possible to assume x(t) periodic, with a period equal to the length of a symbol Tₛ. At the receiver side N samples of the output signal are uniformly collected (reference 200 in FIG. 18) over one symbol, according to the following formula:

$${y}_{n} = ( x * h ) ( {nT}_{s} / N ) + {ɛ}_{n} = {\sum }_{k = 1}^{K} {c}_{k} x ( {nT}_{s} / N - {t}_{k} ) + {ɛ}_{n} \\ n = 0 , … , N - 1 \qquad ( 7 )$$

where εₙ is some noise. The sampling is performed with a sampling rate below the Nyquist rate, as described in EP1396085 and in the relative paper Sampling Signals With Finite Rate of Innovation Martin Vetterli, Pina Marziliano, and Thierry Blu, IEEE Transactions on signal processing, Vol. 50, Nr. 6, pp. 1417-1428, June 2002. The minimum number of samples for estimating the 2K parameters of the impulse response of the channel is 2K+1. However, given that the rate of innovation of the signal is ρ, a number N of samples superior than ρτ is considered to fight the perturbation εₙ, making the data redundant by a factor of N/(ρτ). This redundancy is used for denoising.

After the sampling, a FFT is applied to the sampled signal yₙ (reference 300 in FIG. 19) and a test is performed on the obtained signal ŷₙ evaluating its noise level (reference 500 in FIG. 19). If the level noise is higher than a predefined threshold, it is necessary to denoised it by performing some iterations of an iterative denoising method, named in the following “Cadzow's Iterative denoising” (reference 400 in FIG. 19), described in the Appendix A, before applying the Annihilating filter method (reference 600 in FIG. 19), described in the Appendix B.

Applying the Annihilating filter method allows to determine the delays D·tₖ. For D>1 the Annihilating filter's roots are raised to the power of D, i.e. the corresponding polynomial is in term of x^{D} instead of x. In other words the set of roots is {e^{-j2πDt}^{ₖ}}_{k=1, . . . , K} and these roots are linked to the temporal locations or delays tₖ by a factor D. They have to be divided by D as defined in (4) and (5), for found the searched delays tₖ. Once the set of roots is known, the Annihilating filter is used for synthesising the spectrum of the impulse response, i.e. for performing a polynomial interpolation of its impulse response.

By applying some linear algebraic operations on yₙ and on found tₖ, the amplitudes cₖ can be estimated. In fact the described FIR method allows a 2-steps parameters estimation: first the temporal locations or delays tₖ and then the amplitudes Cₖ.

The number of pilots is selected by computer processing means based on the finite rate of innovation of the channel; in one embodiment this number is equal or superior to 2K+1, wherein K is the sparsity of the channel. In one embodiment, this number is selected based also to the noise of the channel: in fact if the channel has low noise, a low number of pilots, e.g. 2K+1, allows to robustly estimate the channel. It is also possible to sent number of pilots higher than 2K+1: in such a case the estimation of the channel is more robust against the noise than the known method using the same number of pilots. The number of pilots can be selected once for a given apparatus and channel, or adapted at different instant in time to varying properties of the channel or of its signal-to-noise ratio. It is also possible to adjust continuously or before each transmission this number of pilots to the current conditions of a channel.

D=1 means that pilots are contiguous as illustrated in FIG. 16. In this case the method can be used for allocating M pilots out of the N data or DFT coefficients forming a symbol, where 2K<M≦N. Moreover centering them around the zero-frequency or baseband leads to more efficient calculations since some systems involve Hermitian matrices. In this particular case—contiguous pilots around the basebands—the method exploits only the sparsity property of the channel, since few pilots are sent to the channel, but it does not consider the limitation in time of its impulse response. Moreover using close pilots reduces the robustness of the method. In such a method the impulse response of the channel is estimated by extrapolation of the found solutions, illustrated in FIG. 17, i.e. some recursion coefficients are used forward and backward for filling all the channel spectrum starting from the portion of the spectrum known by the pilots.

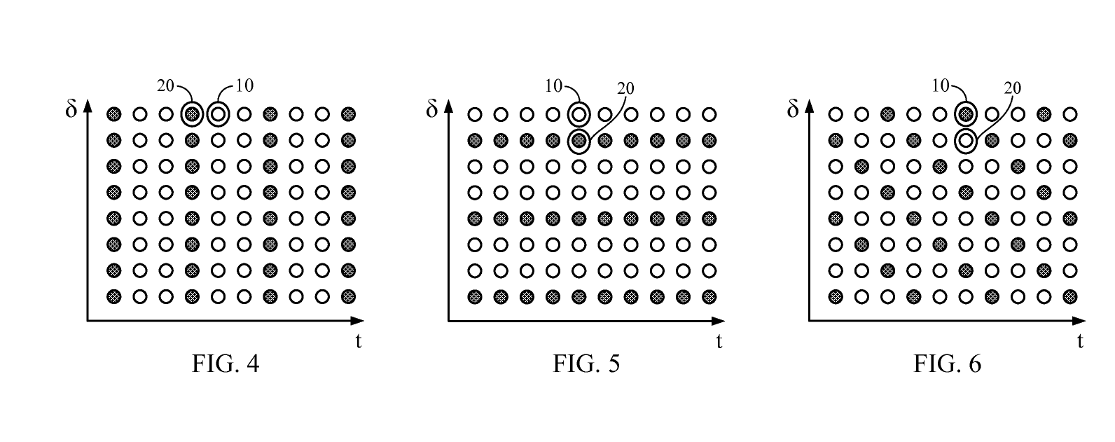

In OFDM, data and pilots are encoded directly as DFT coefficients. The application of the illustrated method is then direct and it works for all three popular pilot layouts shown in FIGS. 4 to 6. The comb-layout is the most widely used. An example of setting DFT pilots in the WHT domain is given in the appendix F.

The described method for estimating a sparse channel having an impulse response limited in time can be used for any channel having an orthonormal basis (ONB), e.g. OxDM channel, in which the DFT space W can be partitioned in two sets W_{data} and Wₚᵢₗₒₜ such that

W=W_{data}+Wₚᵢₗₒₜ s.t. W_{data}⊥Wₚᵢₗₒₜ (8)

The partition according to (8) implies data/pilot independence. Partitioning the DFT space mathematically means that the DFT matrix W and the ONB matrix Q are 2-blocks diagonalized by a permutation of rows Pᵣ and of columns P_{c}, i.e.

$${P}_{c} WQ * {P}_{r} = [ \begin{matrix}{U}_{p} & 𝕆 \\ 𝕆 & {U}_{d}\end{matrix} ]$$

where both diagonal blocks Uₚ and U_{d} are unitary. Properties like the conservation of the pilots' energy can be derived from (8) (see Appendix C for further details).

By this way the method according to one embodiment of the invention can be applied also to a synchronous CDMA, i.e. a scenario in which a single emitter, e.g. a base station, uses code multiplexing to communicate with several receivers, e.g. mobile devices. An extremely popular code in this scenario is the Walsh-Hadamard code. Some of its desirable features are:
maximum distance between code words
maximum determinant among binary matrices
fastest known “Fourier-like” transform (only requires additions, subtractions and permutations)
perfect orthogonality.

The Walsh-Hadamard code is, among others, used in the IS-95 standard. For a symbol of length 2^{N} it is possible to select a subset of 2^{Np} pilots before the Walsh-Hadamard encoding to set 2^{Np} DFT coefficients of the encoded signal. Moreover the DFT coefficients to be set may be arranged in a comb or scattered layout with pilot spacing

D=2^{N}−2^{Np} (10)

in frequency, where the maximum value of D is given by (5).

As a corollary, the energy of the pilot is equal to the energy of the DFT coefficients which have been set, in other words nothing is lost.

Generally speaking the mentioned method can be applied without energy losses for estimating a sparse channel having an impulse response limited in time under a generic channel coding, if such a coding can be partitioned in the frequency domain in two independent sets of vectors. In other words if the code-words (vectors) can be partitioned into two sets, Data and Pilot, such that, Data and Pilot, such that:

1. W_{data}=span Data
2. Wₚᵢₗₒₜ=span Pilot
3. W_{data} orthogonal to Wₚᵢₗₒₜ
4. Wₚᵢₗₒₜ has to be spanned by DFT basis vectors uniformly laid-out by a factor D>0.

See the Appendix D for further details.

Appendix E illustrates also that computing the DFT on a torus requires less computation than a regular DFT of the same size and the factorisation is compatible with the comb and scattered pilots layouts.

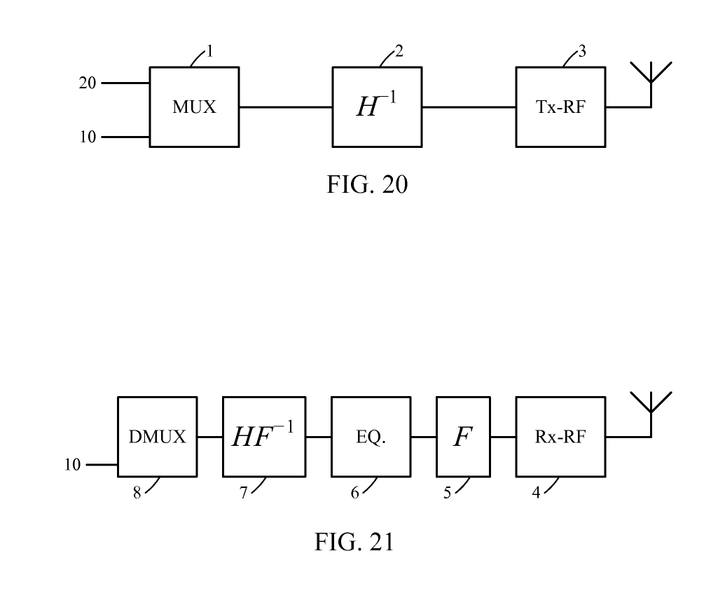

FIGS. 20 and 21 show respectively an example of the TX and RX chain for an Orthogonal Hadamard Division Multiplexing (OHDM) system using the Hadamard Transform H in the case of a Single Carrier Frequency Division multiplexing (SC-FDMA) or in general in the case of a low-resources transmitter. In such a case in the transmission chain of FIG. 20 an anti-Hadamard transform H⁻¹ 2 is applied to a signal which multiplexes data and pilots (reference 1 in FIG. 20). The resultant signal is then transmitted (reference 3 in FIG. 20). Once received (reference 4 in FIG. 21), a classical Fourier transform 5 is applied to the received signal and, after an equalisation channel step (reference 6 in FIG. 21), an anti-Fourier transform and an Hadamard transform are then applied (reference 7 in FIG. 21) before the de-multiplexing (reference 8 in FIG. 21). In such a case without extra-cost at the transmitter, the anti-Hadamard transform provides itself the frequency diversity which is necessary for such a system. In other words a pre-processing step at the transmitter for performing the frequency diversity is not needed. This solution is then cheaper than the classical solution using FFT. Moreover it enables scattered and comb Fourier pilots' equalisation on Hadamard modulated communications.

In one embodiment the means for sending comprise an emitting circuit, e.g. an RF or microwave emitting circuit.

In one embodiment the means for receiving comprise a receiving circuit, e.g. an RF or microwave receiving circuit.

In one embodiment the means for low-pass filtering comprise a hardware-implemented low-pass filter or a software-implemented low-pass filter.

In one embodiment the means for sampling comprise a hardware-implemented sampler or a software-implemented sampler.

In one embodiment the means for applying a FFT or the means for verifying the level of noise or the means for applying an annihilating filter method or means for dividing temporal parameters or means for solving a linear algebraic system or means for applying a denoising procedure comprise at least one processor, such as one or more digital signal processors (DSPs), general purpose microprocessors, application specific integrated circuits (ASICs), field programmable logic arrays (FPGAs), or other equivalent integrated or discrete logic circuitry.

In one or more examples, the functions described may be implemented in hardware, software, firmware, or any combination thereof. If implemented in software, the functions may be stored on or transmitted over as one or more instructions or code on a computer-readable medium. Computer-readable media may includes computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (i.e., a chip set). Various components, modules or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

It is to be understood that the claims are not limited to the precise configuration and components illustrated above. Various modifications, changes and variations may be made in the arrangement, operation and details of the methods and apparatus described above without departing from the scope of the claims.

### APPENDIX A

### Cadzow's Iterative Denoising

Computing the N-DFT coefficients of the samples

$${\hat{y}}_{m} = {\sum }_{n = 1}^{N} {y}_{n} {e}^{- j 2 π nm / N}$$

Choosing an integer L in [K, Bτ/2] and building the rectangular Toeplitz matrix according to

$$A = 2 M - + 1 rows \{ \overbrace{[ \begin{matrix}{\hat{y}}_{- M + L} & {\hat{y}}_{- M + L} & ⋯ & {\hat{y}}_{- M} \\ {\hat{y}}_{- M + L + 1} & {\hat{y}}_{- M + L} & ⋯ & {\hat{y}}_{- M + 1} \\ ⋮ & ⋱ & ⋱ & ⋮ \\ ⋮ & ⋱ & ⋱ & ⋮ \\ ⋮ & ⋱ & ⋱ & ⋮ \\ {\hat{y}}_{M} & {\hat{y}}_{M - 1} & ⋯ & {\hat{y}}_{M - L}\end{matrix} ]}^{L + 1 columns} \\ where M = ⌊ B τ / 2 ⌋ .$$

Performing the Singular Value Decomposition (SVD) of the matrix A=USV^{T}, where U is a (2M−L+1)×(L+1) unitary matrix, S is a diagonal (L+1)×(L+1) matrix and V is a (L+1)×(L+1) unitary matrix.
Building the diagonal matrix S′ from S by keeping only the K most significant diagonal elements, and deducing the total least-squares approximation of A by A′=US′V^{T}.
Building a denoising approximation ŷₙ′ of ŷₙ by averaging the diagonals of the matrix A′.
Iterating the second step until the (K+1)^{th} largest diagonal element of S is smaller than the K^{th} largest diagonal element by some pre-requisite factor.

The number of iterations needed is usually small, about ten. Experimentally the best choice for L in the second step is L=M.

### APPENDIX B

### Annihilating Filter Method on Uniformly Laid Out DFT Pilots

Method for retrieving the innovations cₖ and tₖ from the noisy sample yₙ

Throughout this appendix we use the periodicity of the DFT to index equivalently N-points DFT coefficients between 0 and N−1 or between

$$- ⌈ \frac{N}{2} ⌉ and ⌈ \frac{N}{2} ⌉ - 1$$

with the appropriate mapping.

Let the sequence ŷₗ^{up} be the N-points DFT of yₙ for n=0, 2, . . . , N−1

$${\hat{y}}_{l}^{up} = {\sum }_{k = 1}^{K} {c}_{k} {e}^{- j 2 π {lt}_{k} / τ } for 1 = 0 , … , N - 1$$

By assumption yₙ are samples of a periodic (of period τ) stream of K dirac observed through a sampling kernel corrupted by some additive noise. For simplicity we choose the sampling kernel to be a sinc of bandwidth B, then:

$${\hat{y}}_{l}^{up} = {\sum }_{k = 1}^{K} {c}_{k} {e}^{- j 2 π {lt}_{k} / τ } for \vert 1 \vert \leq {N}^{′} such that {N}^{′} = ⌊ B τ / 2 ⌋$$

Only a subset of 2M+1 of these coefficients is available. The indices of the available coefficients are:

$${\hat{y}}_{m} = {\hat{y}}_{m}^{up} [ m D + {m}_{0} ] = {\sum }_{k = 1}^{K} {c}_{k} {e}^{- j 2 π {mt}_{k} / τ } {e}^{- j 2 π {m}_{0} {t}_{k} / τ}$$

such that |m|≦M and m0 is some integer offset.
Choosing L=K and building a rectangular Toeplitz matrix according to

$$A = 2 M - L + 1 rows \{ {\overbrace{[ \begin{matrix}\hat{y} - M + L & \hat{y} - M + L - 1 & ⋯ & \hat{y} - M \\ \hat{y} - M + L + 1 & \hat{y} - M + L & ⋯ & \hat{y} - M + 1 \\ ⋮ & ⋱ & ⋱ & ⋮ \\ ⋮ & ⋱ & ⋱ & ⋮ \\ ⋮ & ⋱ & ⋱ & ⋮ \\ \hat{y} M & \hat{y} M - 1 & ⋯ & \hat{y} M - L\end{matrix} ]}}^{L + 1 column s}$$

Performing a Singular Value Decomposition (SVD) of the matrix A and choosing the eigenvector [h₀, h₁, . . . , hₖ]^{T} corresponding to the smallest eigenvalue, i.e. the annihilating filter coefficient.
Computing the roots (e^{-j2πt}^{ₖ}^{/τ})^{D} of the z-transform

$$H ( z ) = {\sum }_{k = 0}^{K} {h}_{k} {z}^{- k}$$

and deducing {Dtₖ}_{k=1, . . . , K}
Computing the least mean square (LMS) solution cₖ of the N equations:

$${\hat{y}}_{m} = {\sum }_{k = 0}^{K} {c}_{k} {e}^{- j2π m {Dt}_{k} / τ} {e}^{- j2π {m}_{0} {t}_{k} / τ} for \vert m \vert \leq M$$

When the measurements yₙ are noisy it is necessary to first denoised them by performing a few iterations of the method of the Appendix A.

### APPENDIX C

### DFT Domain Channel Estimation Under Generic Channel Coding

Let Pᵣ and P_{c} be permutations of rows and columns, W be the DFT matrix and Q unitary (ONB) spanning the signal domain. x is the vector of coefficients to be transmitted and ŷ the DFT of the received signal:

ŷ=WQ*x (C1)

The pilot and data coefficients are named with the index p respectively d, by permutation of rows and columns one obtain:

$$⌊ \frac{{\hat{y}}_{p}}{{\hat{y}}_{d}} ⌋ = {P}_{c} {WQ}^{*} {P}_{r} x = ⌊ \frac{{W}_{p}}{{W}_{d}} ⌋ [ {Q}_{p}^{*} \vert {Q}_{d}^{*} ] ⌊ \frac{{x}_{p}}{{x}_{d}} ⌋ \qquad ( C2 )$$

One basic property the system should have is conservation of pilot power, i.e ∥ŷₚ∥₂=∥xₚ∥₂ for any possible data xd. From the equation (C2):

WₚQₚ*xₚ=ŷₚ−WₚQ_{d}*x_{d} (C3)

Independence with respect to x_{d} implies WₚW_{d}= [symbol] since the row space of Wₚ cannot be orthogonal to ŷₚ (otherwise so is WₚQₚ*xₚ). A product of unitary matrix is unitary, so that:

$${P}_{c} {WQ}^{*} {{P}_{r} ( {P}_{c} {WQ}^{*} {P}_{r} )}^{*} = [ \begin{matrix}{W}_{p} {{Q}_{p}^{*} ( {W}_{p} {Q}_{p}^{*} )}^{*} & 𝕆 \\ 𝕆 & {W}_{d} {{Q}_{d}^{*} ( {W}_{d} {Q}_{d}^{*} )}^{*}\end{matrix} ] = 1 \qquad ( C4 )$$

From (C4) it is possible to conclude that WₚQₚ* is unitary and so is W_{d}Q_{d}*. Moreover W_{d}Qₚ*=(WₚQ_{d}*)* and it is equal to the null matrix so that:

$${P}_{c} {WQ}^{*} {P}_{r} = [ \begin{matrix}{U}_{p} & 𝕆 \\ 𝕆 & {U}_{d}\end{matrix} ] \qquad ( C5 )$$

with Uₚ and U_{d} unitary. A possible way to see it is to partition the signal space W in a pilot subspace and a data subspace in the signal domain W=Qₚ∪Q_{d} and in the DFT domain W=Wₚ∪W_{d}. The conservation of pilots energy boils down to the following statement

∥proj_{W}_{ₚ}xₚ∥₂=∥xₚ∥₂ ∀xₚεQₚ [symbol] Wₚ=Qₚ (C6)

since Wₚ and Qₚ have the same dimension. At the end of the day ONBs with conservation of pilot energy property are just unions of different representations of Wₚ and W_{d}.

### APPENDIX D

### An Example

### The Hadamard Transform

If one take W the space of sequences having a N-points DFT representations, where N=2ⁿ, and Wₚ=span ({w_{N}^{k}}_{k=Ki:2}ⁱ_{:N}), where w_{N}^{k} is the k^{th} N-points DFT vector w_{N}^{k}=[e^{-2πjl/N}]_{l=0:(N-1)}, a downsampling by 2ⁱ with proper offset Kᵢ in the DFT domain, the bases vectors of the Hadamard transform may be split in two subset spanning Wₚ and W_{d} respectively.

To show it, one can consider the Sylvester's construction of the Hadamard matrix:

$${H}_{0} = [ 1 ] , {H}_{i + 1} = ( \begin{matrix}{H}_{i} & {H}_{i} \\ {H}_{i} & - {H}_{i}\end{matrix} ) , s . t . i εℕ .$$

If hⁿ is a vector from the right half of Hₙ the Hadamard matrix of size N, its inner product with the k^{th} DFT vector is

$$\begin{matrix}〈 {w}_{N}^{k} , {h}^{( n )} 〉 = {\sum }_{l = 0}^{N - 1} {w}_{N}^{kl} {h}_{l}^{( n )} \\ = {\sum }_{l = 0}^{N / 2 - 1} {w}_{N}^{kl} {h}_{l}^{( n )} + {w}_{N}^{k ( l + N / 2 )} {h}_{l + N / 2}^{( n )} \\ = {\sum }_{l = 0}^{N / 2 - 1} {w}_{N}^{kl} {h}_{l}^{( n )} ( 1 - {w}_{N}^{kN / 2} )\end{matrix}$$

So h⊥w_{N}^{k} for k even. By a dimensional argument, it is possible to conclude the right half of Hₙ spans span ({w_{N}^{k}}_{k=1:2:N}), and the left half spans span ({w_{N}^{k}}_{k=0:2:N}).

Then, by construction, the left half of the Hadamard matrix is N/2 periodic, so for k=2k′, k′ε{0, . . . , 2ⁿ⁻¹−1}, it verifies

$$〈 {w}_{{2}^{n}}^{k} , ( \begin{matrix}{h}^{( n - 1 )} \\ {h}^{( n - 1 )}\end{matrix} ) 〉 = 〈 {w}_{2 ( n - 1 )}^{{k}^{′}} , {h}^{( n - 1 )} 〉$$

The above method is applied recursively to get

span col{Hₙ[2ⁿ⁻ⁱ⁻¹:2ⁿ⁻ⁱ]}=span {w_{N}^{k}}₂_{ⁱ}_{:2}_{⁺¹}_{:N}, iε{0, . . . , n−2}

and {Hₙ[0], Hₙ[1]} have the same span as {w_{N}⁰, w_{N}^{N/2}}.

It means:

The comb pilot layout with 2ⁱ spacing (i≦n) can be used on Hadamard multiplexed transmissions of frame size 2ⁿ to do regular DFT domain channel estimation.

### APPENDIX E

### An Example

### DFT on Tori

The usual N-points DFT can be interpreted as the Fourier Transform over the inner-product space L₂( [symbol] /N [symbol] ), of square-integrable sequences [symbol] /N

[symbol]

With this interpretation, the N-points Hadamard transform—with N a power of 2—is the Fourier transform over (( [symbol] /2 [symbol] )^{log}^{₂}^{N}).

The question is to address generalization of the result on the Hadamard transform. Namely, if

$$N = {\prod }^{R} {n}_{r}$$

for any set of integers {nᵣ}, does a similar result holds for the torus G_{τ}⊕ᵣ₌₁^{R} [symbol] /nᵣ [symbol] where ⊕ represents the direct sum operator. {nᵣ} does not have to be the set of prime factors of n, i.e. N=70 is fine.

First, one have to define the DFT on a torus. It is known that the characters of torus G_{τ} are of the form Xn(x)=Πᵣ₌₁^{R} w_{αr}^{αr xr}, ∀n, xεG_{τ}.

With this definition, the DFT matrix on G_{τ} is:

$${W}_{⊗ {n}_{r}} = {{⊗}_{r = 1}}^{R} {W}_{{n}_{r}}$$

where [symbol] nᵣ is the Kronecker-product of nᵣ-points DFT matrices. This kind of product is not commutative, i.e. the first index corresponds to the leftmost term.

If one considers Wₙ [symbol] . . . =Wₙ [symbol] \tilde{W} such that \tilde{W} Wₙ [symbol] . . . the DFT matrix of some torus and N=n×m, pictorially

$${W}_{n ⊗ …} = [ \begin{matrix}\tilde{W} & \tilde{W} & \tilde{W} & ⋯ & \tilde{W} \\ \tilde{W} & {w}_{n} \tilde{W} & {w}_{n}^{2} \tilde{W} & ⋯ & {w}_{n}^{n - 1} \tilde{W} \\ \tilde{W} & {w}_{n}^{2} \tilde{W} & {w}_{n}^{2 - 2} \tilde{W} & ⋯ & {w}_{n}^{2 ( n - 1 )} \tilde{W} \\ ⋮ & ⋮ & ⋮ & & ⋮ \\ \tilde{W} & {w}_{n}^{n - 1} \tilde{W} & {w}_{n}^{2 ( n - 1 )} \tilde{W} & ⋯ & {w}_{n}^{( n - 1 ) ( n - 1 )} \tilde{W}\end{matrix} ] = [ {W}_{n ⊗ …}^{( 0 )} {…W}_{n ⊗ …}^{( n - 1 )} ]$$

For demonstrating the previous formula, one considers any column h⁽ⁱ⁾ of the previous matrix and calls \tilde{W} relevant column of \tilde{W}. Its inner product with the k^{t}h N-points DFT vector is then calculated:

$$\begin{matrix}〈 {w}_{N}^{k} , {h}^{( i )} 〉 = {\sum }_{p = 0}^{n - 1} {\sum }_{q = 0}^{m - 1} {w}_{N}^{k ( pm + q )} {w}_{n}^{- pi} {\tilde{W}}_{q} \\ = {α}_{q , k , N , \tilde{W}} {\sum }_{p = 0}^{n - 1} {w}_{n}^{p ( k - i )} .\end{matrix}$$

Thus [symbol] w_{N}^{k}, h⁽ⁱ⁾ [symbol] =0 if k−1=0 mod n, which means [symbol] has the same span as the i^{th} coset of DFT vectors under downsampling by a factor n.

By periodicity of [symbol] it is possible to apply the above procedure recursively on \tilde{W}.

### APPENDIX F

### Setting DFT Pilots in the Walsh-Hadamard Transform (WHT) Domain

We assume the transmitted frame contains 16 samples. “*” is the hermitian transpose throughout the documents

W is the 16-pts DFT matrix.

H is the 16-pts WHT matrix

$$H = 1 / 4 x \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ - 1\end{matrix} \\ - 1\end{matrix} \\ 1\end{matrix} \\ - 1\end{matrix} \\ 1\end{matrix} \\ 1\end{matrix} \\ - 1\end{matrix} \\ - 1\end{matrix} \\ 1\end{matrix} \\ 1\end{matrix} \\ - 1\end{matrix} \\ 1\end{matrix} \\ - 1\end{matrix} \\ - 1\end{matrix} \\ 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ 1\end{matrix} \\ - 1\end{matrix} \\ - 1\end{matrix} \\ - 1\end{matrix} \\ - 1\end{matrix} \\ 1\end{matrix} \\ 1\end{matrix} \\ - 1\end{matrix} \\ - 1\end{matrix} \\ 1\end{matrix} \\ 1\end{matrix} \\ 1\end{matrix} \\ 1\end{matrix} \\ - 1\end{matrix} \\ - 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ - 1\end{matrix} \\ 1\end{matrix} \\ - 1\end{matrix} \\ - 1\end{matrix} \\ 1\end{matrix} \\ - 1\end{matrix} \\ 1\end{matrix} \\ - 1\end{matrix} \\ 1\end{matrix} \\ - 1\end{matrix} \\ 1\end{matrix} \\ 1\end{matrix} \\ - 1\end{matrix} \\ 1\end{matrix} \\ - 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ 1\end{matrix} \\ 1\end{matrix} \\ 1\end{matrix} \\ - 1\end{matrix} \\ - 1\end{matrix} \\ - 1\end{matrix} \\ - 1\end{matrix} \\ - 1\end{matrix} \\ - 1\end{matrix} \\ - 1\end{matrix} \\ - 1\end{matrix} \\ 1\end{matrix} \\ 1\end{matrix} \\ 1\end{matrix} \\ 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ - 1\end{matrix} \\ - 1\end{matrix} \\ 1\end{matrix} \\ 1\end{matrix} \\ - 1\end{matrix} \\ - 1\end{matrix} \\ 1\end{matrix} \\ - 1\end{matrix} \\ 1\end{matrix} \\ 1\end{matrix} \\ - 1\end{matrix} \\ - 1\end{matrix} \\ 1\end{matrix} \\ 1\end{matrix} \\ - 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ 1\end{matrix} \\ - 1\end{matrix} \\ - 1\end{matrix} \\ 1\end{matrix} \\ 1\end{matrix} \\ - 1\end{matrix} \\ - 1\end{matrix} \\ - 1\end{matrix} \\ - 1\end{matrix} \\ 1\end{matrix} \\ 1\end{matrix} \\ - 1\end{matrix} \\ - 1\end{matrix} \\ 1\end{matrix} \\ 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ - 1\end{matrix} \\ 1\end{matrix} \\ - 1\end{matrix} \\ 1\end{matrix} \\ - 1\end{matrix} \\ 1\end{matrix} \\ - 1\end{matrix} \\ - 1\end{matrix} \\ 1\end{matrix} \\ - 1\end{matrix} \\ 1\end{matrix} \\ - 1\end{matrix} \\ 1\end{matrix} \\ - 1\end{matrix} \\ 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ 1\end{matrix} \\ 1\end{matrix} \\ 1\end{matrix} \\ 1\end{matrix} \\ 1\end{matrix} \\ 1\end{matrix} \\ 1\end{matrix} \\ - 1\end{matrix} \\ - 1\end{matrix} \\ - 1\end{matrix} \\ - 1\end{matrix} \\ - 1\end{matrix} \\ - 1\end{matrix} \\ - 1\end{matrix} \\ - 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ - 1\end{matrix} \\ - 1\end{matrix} \\ 1\end{matrix} \\ - 1\end{matrix} \\ 1\end{matrix} \\ 1\end{matrix} \\ - 1\end{matrix} \\ 1\end{matrix} \\ - 1\end{matrix} \\ - 1\end{matrix} \\ 1\end{matrix} \\ - 1\end{matrix} \\ 1\end{matrix} \\ 1\end{matrix} \\ - 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ 1\end{matrix} \\ - 1\end{matrix} \\ - 1\end{matrix} \\ - 1\end{matrix} \\ - 1\end{matrix} \\ 1\end{matrix} \\ 1\end{matrix} \\ 1\end{matrix} \\ 1\end{matrix} \\ - 1\end{matrix} \\ - 1\end{matrix} \\ - 1\end{matrix} \\ - 1\end{matrix} \\ 1\end{matrix} \\ 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ - 1\end{matrix} \\ 1\end{matrix} \\ - 1\end{matrix} \\ - 1\end{matrix} \\ 1\end{matrix} \\ - 1\end{matrix} \\ 1\end{matrix} \\ 1\end{matrix} \\ - 1\end{matrix} \\ 1\end{matrix} \\ - 1\end{matrix} \\ - 1\end{matrix} \\ 1\end{matrix} \\ - 1\end{matrix} \\ 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ 1\end{matrix} \\ 1\end{matrix} \\ 1\end{matrix} \\ - 1\end{matrix} \\ - 1\end{matrix} \\ - 1\end{matrix} \\ - 1\end{matrix} \\ 1\end{matrix} \\ 1\end{matrix} \\ 1\end{matrix} \\ 1\end{matrix} \\ - 1\end{matrix} \\ - 1\end{matrix} \\ - 1\end{matrix} \\ - 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ - 1\end{matrix} \\ - 1\end{matrix} \\ 1\end{matrix} \\ 1\end{matrix} \\ - 1\end{matrix} \\ - 1\end{matrix} \\ 1\end{matrix} \\ 1\end{matrix} \\ - 1\end{matrix} \\ - 1\end{matrix} \\ 1\end{matrix} \\ 1\end{matrix} \\ - 1\end{matrix} \\ - 1\end{matrix} \\ 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ 1\end{matrix} \\ - 1\end{matrix} \\ - 1\end{matrix} \\ 1\end{matrix} \\ 1\end{matrix} \\ - 1\end{matrix} \\ - 1\end{matrix} \\ 1\end{matrix} \\ 1\end{matrix} \\ - 1\end{matrix} \\ - 1\end{matrix} \\ 1\end{matrix} \\ 1\end{matrix} \\ - 1\end{matrix} \\ - 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ - 1\end{matrix} \\ 1\end{matrix} \\ - 1\end{matrix} \\ 1\end{matrix} \\ - 1\end{matrix} \\ 1\end{matrix} \\ - 1\end{matrix} \\ 1\end{matrix} \\ - 1\end{matrix} \\ 1\end{matrix} \\ - 1\end{matrix} \\ 1\end{matrix} \\ - 1\end{matrix} \\ 1\end{matrix} \\ - 1\end{matrix} \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}1 \\ 1\end{matrix} \\ 1\end{matrix} \\ 1\end{matrix} \\ 1\end{matrix} \\ 1\end{matrix} \\ 1\end{matrix} \\ 1\end{matrix} \\ 1\end{matrix} \\ 1\end{matrix} \\ 1\end{matrix} \\ 1\end{matrix} \\ 1\end{matrix} \\ 1\end{matrix} \\ 1\end{matrix} \\ 1\end{matrix}$$

1st example: we want to set 4 uniformly laid-out pilots.

From the last formula of the appendix D, we know we should use WHT codewords 5 6 7 and 8. Since WHT is a unitary transform, we can set them to 1 to get unit norm DFT pilots:

x*=[d d d d 1 1 1 1 d d d d d d d d]

The symbol d represents slots available for data.

We put random noise in the data slots to show the applicability of the method:

x*=[0.6934 −0.2382 0.5998 0.7086 1 1 1 1 −0.9394 −0.0065 −0.0531 −0.1648 0.0101 0.1601 −1.4654 −0.0396]

The data are encoded by the WHT matrix:

y=(H*)x

In the DFT domain, y is:

(W*y)=

0.693389551907565+0.00000000000000i

0.0376122250608119+0.221619563947701i

0.707106781186548−0.707106781186548i

0.474412735639293+0.793635553191344i

0.0544469825889248−0.654202368485755i

0.662818076004277+0.445493169312805i

−0.707106781186548−0.707106781186548i

−0.0146303927594001−0.0109274329590536i

0.238187257168569+0.00000000000000i

−0.0146303927594001+0.0109274329590536i

−0.707106781186548+0.707106781186548i

0.662818076004277−0.445493169312805i

0.0544469825889248+0.654202368485755i

0.474412735639293−0.793635553191344i

0.707106781186548+0.707106781186548i

0.0376122250608119−0.221619563947701i

We have set 4 pilots in the DFT domain, and they have unit norm. The phase shift of pi/4 is predictable.

We could have done easily the same for any power of 2<=16 (like 8 for example)

The method can be applied to WHT and DFT with a power of 2 size (not necessarily 16).

1. A method for sending a selected number of pilots to a sparse channel having a channel impulse response limited in time comprising:
sending said selected number of said pilots,
wherein
said pilots are equally spaced in the frequency domain; and
said number is selected based on the finite rate of innovation of said channel impulse response.

2. The method of claim 1, wherein said number is equal or superior to 2K+1, wherein K is the sparsity of said channel impulse response.

3. The method of claim 1, wherein said number is selected based on the noise of said channel.

4. The method of claim 1, wherein the maximum distance between two consecutive pilots is given by the floor function of the ratio between the length of a symbol sent to said channel and the max delay-spread of said impulse response of said channel.

5. The method of claim 1, wherein said pilots are DFT domain pilots.

6. The method of claim 5, wherein said pilots are block pilots.

7. The method of claim 5, wherein said pilots are comb pilots.

8. The method of claim 5, wherein said pilots are scattered pilots.

9. The method of claim 1, said channel being a wireless RF channel.

10. The method of claim 1, said channel being a wired channel.

11. The method of claim 1, said pilots being electromagnetic signals.

12. The method of claim 1, said channel being an OFDM channel.

13. The method of claim 1, said channel being synchronous CDMA channel which uses a code partitioned in two sets of vectors independent in the frequency domain.

14. The method of claim 13, wherein at least one set corresponds to some pilots equally spaced in the frequency domain.

15. The method of claim 13, said code being a Walsh-Hadamard code.

16. A computer-readable storage medium for causing an apparatus to send a selected number of pilots to a sparse channel having a channel impulse response limited in time, encoded with instructions for causing a programmable processor to:
send said selected number of said pilots;
wherein
said pilots are equally spaced in the frequency domain;
said number is selected based on the finite rate of innovation of said channel impulse response.

17. An apparatus for sending a selected number of pilots to a sparse channel having a channel impulse response limited in time, comprising
means for sending said selected number of said pilots,
wherein
said pilots are equally spaced in the frequency domain; and
said number is selected based on the finite rate of innovation of said channel impulse response.

18. An apparatus for sending a selected number of pilots to a sparse channel having a channel impulse response limited in time, comprising:
an emitting circuit arranged for sending said selected number of said pilots
wherein
said pilots are equally spaced in the frequency domain; and
said number is selected based on the finite rate of innovation of said channel impulse response.

19. The apparatus of claim 18, said apparatus being a radio-transmitter.

20. The apparatus of claim 19, said radio-transmitter being a base station.

21. The apparatus of claim 18, said apparatus being an acoustic echo canceller transmitter.

22. The apparatus of claim 18, said apparatus being a line echo canceller transmitter.

23. A method for estimating a sparse channel having a channel impulse response limited in time comprising:
receiving a selected number of pilots, wherein said pilots are equally spaced in the frequency domain;
low-pass filtering said received pilots and obtaining filtered pilots;
sampling said filtered pilots with a rate below the Nyquist rate of said pilots, and obtaining sampled pilots;
applying a FFT on said sampled pilots and obtaining transformed pilots;
verifying the level of noise of said transformed pilots;
if said level of noise is below to a determined threshold, applying an annihilating filter method to said transformed pilots and obtaining temporal parameters of said channel;
dividing said temporal parameters by the distance between two consecutive pilots.

24. The method of claim 23 further comprising
solving a linear algebraic system containing said temporal parameters and said sampled pilots and computing amplitude parameters of said channel.

25. The method of claim 23 further comprising
applying a denoising procedure if said level of noise is above said determined threshold.

26. The method of claim 25, said denoising procedure comprising a total-least square method.

27. The method of claim 23, wherein said number is equal or superior to 2K+1, wherein K is the sparsity of said channel.

28. The method of claim 23, wherein the maximum distance between two consecutive pilots is given by the floor function of the ratio between the length of a symbol sent to said channel and the max delay-spread of said impulse response of said channel.

29. The method of claim 23, wherein said applying an annihilating filter method comprising finding annihilating filter roots raised to the power of a distance between two consecutive pilots.

30. The method of claim 23, wherein said pilots are block pilots.

31. The method of claim 23, wherein said pilots are comb pilots.

32. The method of claim 23, wherein said pilots are scattered pilots.

33. The method of claim 23, said channel being a wireless RF channel.

34. The method of claim 23, said channel being a wired channel.

35. The method of claim 23, pilots being electromagnetic signals.

36. The method of claim 23, said channel being an OFDM channel.

37. The method of claim 23, said channel being synchronous CDMA channel which uses a code composed by two sets of vectors independent in the frequency domain.

38. The method of claim 37, wherein at least one set corresponds to some samples equally spaced in the frequency domain.

39. The method of claim 38, said code being a Walsh-Hadamard code.

40. A computer-readable storage medium for estimating a sparse channel having a channel impulse response limited in time, encoded with instructions for causing a programmable processor to:
cause an apparatus to receive a selected number of pilots
wherein
said pilots are equally spaced in the frequency domain;
low-pass filter said received pilots and obtain filtered pilots;
sample said filtered pilots with a rate below the Nyquist rate of said pilots and obtain sampled pilots;
apply a FFT on said sampled pilots and obtain transformed pilots;
verify the level of noise of said transformed pilots;
if said level of noise is below to a determined threshold, apply an annihilating filter method to said transformed pilots and obtain temporal parameters of said channel;
divide said temporal parameters by the distance between two consecutive pilots;
solve a linear algebraic system containing said temporal parameters and said sampled pilots and compute amplitude parameters of said channel;
apply a denoising procedure if said level of noise is above said determined threshold.

41. An apparatus for estimating a sparse channel having a channel impulse response limited in time, comprising:
means for receiving a selected number of pilots,
wherein
said pilots are equally spaced in the frequency domain;
means for low-pass filtering said received pilots and obtaining filtered pilots;
means for sampling said filtered pilots with a rate below the Nyquist rate of said pilots and obtaining sampled pilots;
means for applying a FFT on said sampled pilots and obtaining transformed pilots;
means for verifying the level of noise of said transformed pilots;
means for applying, if said level of noise is below to a determined threshold, an annihilating filter method to said transformed pilots and obtaining temporal parameters of said channel;
means for dividing said temporal parameters by the distance between two consecutive pilots;
means for solving a linear algebraic system containing said temporal parameters and said sampled pilots and computing amplitude parameters of said channel;
means for applying a denoising procedure if said level of noise is above said determined threshold.

42. An apparatus for estimating a sparse channel having a channel impulse response limited in time, comprising
a circuit arranged to receive a selected number of pilots, wherein said pilots are equally spaced in the frequency domain;
said apparatus further comprising:
a low-pass filter arranged to filter said received pilots and obtain filtered pilots;
a sampler arranged to sample said filtered pilots with a rate below the Nyquist rate of said pilots and obtain sampled pilots;
a second calculator arranged to apply a FFT on said sampled pilots and obtain transformed pilots;
a third calculator arranged to verify the level of noise of said transformed pilots;
if said level of noise is below to a determined threshold, a fourth calculator arranged to apply an annihilating filter method to said transformed pilots and obtain temporal parameters of said channel;
a fifth calculator arranged to divide said temporal parameters by the distance between two consecutive pilots;
a sixth calculator arranged to solve a linear algebraic system containing said temporal parameters and said sampled pilots and computing amplitude parameters of said channel;
a seventh calculator arranged to apply a denoising procedure if said level of noise is above said determined threshold.

43. The apparatus of claim 42, said apparatus being a radio-receiver.

44. The apparatus of claim 43, said radio-transmitter being a mobile phone.

45. The apparatus of claim 42, said apparatus being an acoustic echo canceller receiver.

46. The apparatus of claim 42, said apparatus being a line echo canceller receiver.

47. The apparatus of claim 42, wherein said second calculator, third calculator, fourth calculator, fifth calculator, sixth calculator and seventh calculator are the same calculator.
